(19) United States
(12) Patent Application Publication
(10) Pub. No.: US 2026/0141128 A1
(43) Pub. Date: May 21, 2026

(54) DELTA PROPAGATION USING OVERRIDES FOR DISTRIBUTED COLLABORATIVE CONTENT CREATION APPLICATIONS

(71) Applicant: NVIDIA Corporation, Santa Clara, CA (US)

(72) Inventors: Kelly Eric BOWMAN, Santa Clara, CA (US); Paul CUTSINGER, Santa Clara, CA (US)

(21) Appl. No.: 18/949,321

(22) Filed: Nov. 15, 2024

(51) Int. Cl. G06F 30/10; G06Q 10/101; G06F 111/02

(52) U.S. Cl. CPC G06F 30/10; G06Q 10/101; G06F 2111/02

(57) ABSTRACT

In various examples, override-based data change propagation for distributed collaborative content creation platforms is provided. An override layer may be generated that comprises a representation of a sequence of override primitives that may be applied against a baseline universal scene description (USD) scene definition layer to render an updated/current version of the scene. A digital content creation application may record edits as modifications (overrides) to scene definition primitives are applied. A CCA may propagate the edits to other CCAs at other client nodes subscribed to the CCCP by sending a new layer message to the server of the CCCP, instructing the server to add the override layer to the scene graph of a root USD file. Other CCAs subscribed to the root USD file receive a message from the server that indicates that the new override layer has been added, and may selectively apply propagated override primitives.

### BACKGROUND

Digital content creation applications (CCAs) refer to software applications used to create, edit, manipulate, and/or render three-dimensional (3D) digital content for building 3D virtual worlds, such as for animation, game development, film production, and virtual reality. To create a 3D virtual world, multiple different CCAs – which can be hosted on or accessed by different client nodes -- may be used together to create and enhance various aspects of features and elements that appear within the virtual world. For example, a CCA for computer-aided design (CAD)-based 3D modeling may be used to design structures that define object features, another CCA may be used to create two-dimensional (2D) textures that may be applied to the surfaces of the object features, another CCA may be used to apply lighting effects, such as reflections from surfaces and/or the casting of shadows, and yet another CCA may be used to create background terrains and/or a sky dome for a 3D scene in which the object feature is located. Distributed collaborative content creation platforms (CCCPs), such as NVIDIA’s Omniverse for example, provide tools to establish a common interaction environment within which multiple CCAs may be used by individual content designers to collaboratively create and edit various features of elements within a virtual 3D world in real time.

### SUMMARY

Embodiments of the present disclosure relate to override-based data change propagation for CCCP systems and applications.

In contrast to existing distributed CCCPs, systems and methods are disclosed that generate an override layer that comprises a representation of a sequence of override primitives that may be applied over one or more baseline universal scene description (USD) scene definition layers to render an updated/current version of the scene. More specifically, as a digital CCA is editing or otherwise operating on elements of a scene rendered by a CCCP, the CCA records edits as modifications (overrides) to the primitives defined in one or more scene definition layers associated with those features. A CCA may propagate the edits to other CCAs at other client nodes subscribed to the CCCP by sending a new layer message to the server of the CCCP, instructing the server to add the override layer to the scene graph of the root USD file.

An (e.g., one, some, or each) override primitive indicates the edits made against the definition primitives in the scene definition layers that correspond to those edited features. In other words, in response to one or more edits applied by the CCA, an override layer is generated that comprises a representation of a sequence of override primitives (e.g., a directed acyclic graph) that may be applied against the baseline scene definition layers to render an updated version of the scene.

Other CCAs subscribed to the root USD file receive a message from the server that indicates that the new override layer has been added. The CCAs receive the message about the new layer from the CCCP server, and may elect to read and selectively apply override primitives propagated via the new override layer added to the root USD file. Because the payload of the override layer is reserved for propagating override primitives, it is relatively sparse as compared to scene definition layers that may also carry definition primitives and/or other types of primitives and scene definition information. As such, the propagation of the message comprising the override layer is a relatively lightweight operation consuming substantially fewer computing and/or network resources than transmitting full USD layers.

### BRIEF DESCRIPTION OF THE DRAWINGS

The present systems and methods for override-based data change propagation for distributed collaborative content creation platform systems and applications are described in detail below with reference to the attached drawing figures, wherein:

FIG. 1 is a data flow diagram illustrating a process for an example collaborative environment comprising a content creation platform, in accordance with embodiments of the present disclosure;

FIG. 2 is a data flow diagram illustrating a process for generating USD override layers, in accordance with embodiments of the present disclosure;

FIG. 3 illustrates a process for override layer propagation, in accordance with some embodiments of the present disclosure;

FIG. 4 is a flow diagram illustrating a method for override-based data change propagation for an example collaborative environment comprising a content creation platform, in accordance with embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to override-based data change propagation for distributed collaborative content creation platform systems and applications. Distributed collaborative content creation platforms (CCCPs), such as NVIDIA’s Omniverse for example, provide tools to establish a common interaction environment within which multiple digital content creation applications (CCAs) operated on different client nodes may be used by individual content designers to collaboratively create and edit various features of elements within a virtual 3D world in real time. Real-time collaboration between heterogeneous CCAs can presently be challenging using currently available CCCPs because different CCAs typically use different data formats to represent the content they create. For example, a first content designer using a first CCA may alter an element represented in the common interaction environment provided by a CCCP. In order to share the content with contributors operating CCAs on other client nodes of the CCCP, the first CCA may transmit a representation of the content using a feature-based native file format to a central database of the CCCP. A content designer using an instance of that same CCA on another client node may readily import and understand the native file format of the first CCA – and the feature edits performed on an element - so that the pair of CCAs can (at one or each application) maintain a synchronized representation of the element by exchanging updated file versions using their native file format. However, the same is not necessarily true when a heterogeneous set of CCAs are used by collaborators at different client nodes across the CCCP. With respect to the set of heterogeneous CCAs, these CCAs may not share a native file format so that one CCA may not be able to directly detect and/or interpret all of the operations (e.g., editing of elements and features rendered within the common interaction environment of the CCCP) performed by another CCA simply based on reading a shared native file that includes the edits.

To address such a discordancy, a collaborative CCCP may generate and distribute a boundary representation (BREP) model and/or tessellated representations of edited elements so that one or more (e.g., each) of the set of heterogeneous CCAs at least has the ability to render local representations of the edited elements for viewing at a client node. That is, the CCAs, as well as the CCCP, may maintain their own canonical base representation of elements within the common interaction environment, and receive real-time representations of changes ( which may be referred to as “delta” information) relative to that canonical base representation made via other CCAs on other client nodes. However, propagating BREP and/or tessellated surface CAD representations to share delta information is a relatively inefficient process with respect to the amount of memory used to represent the current state of objects appearing in the common interaction environment. As the complexity of a scene rendered within the common interaction environment increases, the amount and complexity of using BREP and/or tessellated surface CAD representations to convey and store delta information correspondingly increases. Moreover, while BREP and/or tessellated surface CAD representations may reflect changes in appearance made to features and/or elements as rendered within the common interface environment, they do not provide the CCAs at the client nodes with a comprehensive clear delineation of precisely which features of which elements have changed, and how they have been changed.

Universal Scene Description (USD) is a framework of software and file formats for describing geometries, materials, physics, and behavior scenes of a 3D virtual world, where primitives (“prims”) and content are organized into scene description containers referred to as “layers” (a collection of primitives (“prims”) and their properties). In some USD implementations, a USD layer may be populated with data translated from native file formats used by CCAs that contribute content to a common interface environment. That is, at a CCCP client node when a content designer uses a CCA to create and/or edit elements appearing in the common interface environment, the content may be saved in the native file format of that CCA, and further used to populate one or more USD layers corresponding to elements created and/or edited by that CCA. The USD layer may define a contribution to a scene graph of a root USD data structure (e.g., a file comprising a scene graph) that is used to render one or more aspects of elements within the common interface environment. A scene graph is a data structure comprising a set of graph nodes arranged in a graph or tree structure to organize logical and/or special features of a computer graphics scene. Each node may represent an object, attribute, or a transformation matrix that applies to each child node of that node. As such, a USD-compatible CCA working one or more USD layers of a root USD file may synchronize those scene definition layers with the database server of the CCCP. Other USD compatible CCAs may also subscribe (at the CCCP database server node) to those scene definition layers and thereby are able to collaboratively work on (e.g., edit) features of elements represented by primitives using received copies of those layers. However, as a scene rendered within a common interface environment becomes more complex (e.g., with respect to the number of elements and/or the number of defined features of those elements) the number of nodes and/or complexity of scene graphs associated with each scene definition layer may correspondingly grow. As such, facilitating collaboration between CCAs using messages to exchange scene definition layers does not facilitate continued scaling of the scene and may become unwieldy (both at the server node and the respective CCAs) with respect to memory, bandwidth, and time consumed by the exchanging of messages carrying scene definition layers.

In contrast to existing distributed collaborative CCPs, the embodiments of the present disclosure provide for override-based data change propagation for distributed collaborative content creation platform systems and applications. More specifically, as a CCA is editing or otherwise operating on elements of a scene rendered by a CCCP, the CCA records edits as modifications (overrides) to the primitives defined in one or more scene definition layers associated with those features.

For example, an element of the scene within the common interaction environment may comprise an object having the geometry of a cube. The geometry (e.g., dimensions), surface texture (e.g., a 2D surface image), material composition, surface color, and/or lighting environment (e.g., the orientation, color and/or brightness of light from a light source), and/or non-rendered characteristics (e.g., a weight value, an inventory quantity, etc.) are non-limiting examples of features of the cube, whose characteristics may be individually defined by definition primitives included in the scene definition layers that the CCA is subscribed to via the CCCP database server node.

As the CCA performs operations that apply edits to one or more of these features, those operations are tracked at that client node in the form of a sequence of override primitives generated by the CCA. Each override primitive indicates the edits made against the definition primitives in the scene definition layers that correspond to those edited features. For example, the scene definition layers may include a primitive in the definition of the cube that specifies that the surface of the cube is colored red. In the local rendering of the cube generated by the CCA, and for renderings of the cube generated in the common interaction environment by the CCCP, the surface of the cube is also rendered red. The user of the CCA may subsequently apply an edit to change the surface color of the cube to blue. In doing so, the CCA may apply the change based on a non-destructive editing paradigm where the baseline definition primitives in the scene definition layers continue to define the color of the cube as red, but an override primitive at the client node is generated that instructs the CCA to disregard the value of the baseline definition primitive specifying the red color of the cube in favor of the blue color value specified by the override primitive generated in response to the edits made by the CCA. In other words, in response to one or more edits applied by the CCA, an override layer is generated that comprises a representation of a sequence of override primitives (e.g., a directed acyclic graph) that may be applied against the baseline scene definition layers to render an updated/current version of the scene.

Using the USD framework, the CCA may propagate the edits to other CCAs at other client nodes subscribed to the CCCP by sending a new layer message to the server node of the CCCP, instructing the server to add the override layer to the scene graph of the root USD file. Other CCAs subscribed to the root USD file receive a message from the server node that indicates that the new override layer has been added. The CCAs receive the message about the new layer from the CCCP server node, and may elect to read and selectively apply override primitives propagated via the new override layer added to the root USD file. Because the payload of the override layer is reserved for propagating override primitives, it is relatively sparse as compared to scene definition layers that may also carry definition primitives and/or other types of primitives and scene definition information. As such, the propagation of the message comprising the override layer is a relatively lightweight operation consuming substantially fewer computing and/or network resources than transmitting full USD layers.

In some embodiments, the new layer message comprising the override layer may comprise an ASCII-, or other text, based representation of the override primitives, or a representation compressed into a binary serialization or other format to make the message smaller and/or less resource-intensive to transport. In some embodiments, the override layer may be communicated to the CCCP server node and/or propagated to one or more CCAs as a USD payload. The CCCP may comprise one or more application programming interfaces (APIs) that are exposed to the CCAs at client nodes to permit the CCAs to perform one or more of the override layer propagation functions described herein. For example, a CCA may send a call to a messaging application programming interface (API) to send the CCCP server node a message that includes a new override layer to propagate edits made by that CCA. Another API may implement a subscription function used by CCAs to specify layers of the root USD file for which they subscribe to receive notifications when corresponding new override layers become available.

The CCAs receiving the propagated override layer (via the message from the CCCP server node) may thus be notified of precisely which features of which elements were updated by the CCA applying the edits, and what the updated parameter values of those features are. The CCA receiving the propagated override layer may parse through the sequence of override primitives to identify edits in features that are relevant for that CCA – and disregard further processing of override primitives deemed not relevant. For example, a first CCA that manages surface textures of an element within the common interaction environment may disregard override primitives that rearrange the position (e.g., location and/or rotation) of that element, since surface texture and object position are fully independent features of the element.

In some embodiments, because the override primitives are presented in the override layer sequentially in the order that the edit operations were performed, a CCA receiving the propagated override layer may efficiently parse through the override layer to find the most recent occurrence of an override primitive associated with a feature and apply that override primitive. Override primitives associated with that feature prior to the most recent override primitive may simply be disregarded as stale. For example, if a first override primitive changes a color of a feature of a cube to red, but a later override primitive changes the color of that feature of the cube to yellow, then the CCA receiving the propagated override layer may disregard the first override primitive (changing the color of the feature to red) and apply the change indicated by the later override primitive in the sequence (changing the color of the feature to yellow) assuming there were no more recent subsequent override primitives for that feature – in which case the most recent subsequent override primitive for that feature would be the one applied.

In some embodiments, an override layer may include timestamps applied to override primitives indicating a time that the edit operation was performed and/or that the override layer was created. In such embodiments, the CCA receiving the propagated override layer may determine which override primitives to apply (e.g., the most recent) based at least on one or more of the timestamps. In some embodiments, based on a propagated override layer, a CCA may merge one or more of the override primitives back into the baseline definition primitives in the scene definition layers to establish the updated features as the new baseline definition. That is, the parameters of an override primitive from an override layer may be used to modify a definition primitive specified by other layers of the root USD file. In some embodiments, a propagated override layer may be served by the server node of the distributed collaborative content creation platform using a file format plug that exposes an application programming interface (API) that provides a receiving CCA with an underlying format schema of the propagated override layer to facilitate reading and/or parsing of the override primitives included in that propagated override layer.

In some embodiments, a CCA may determine when to push a new override layer message to the CCCP server node based on one or more criteria. For example, the CCA may push a new override layer message on a manual basis (e.g., based on a user input), based on a predetermined frequency (e.g., once every specified time interval) and/or on an event-based criteria (e.g., the size of an override layer and/or the number of accumulated override primitives reaching a threshold).

In some embodiments, the CCCP server node may implement a conflict management function (e.g., algorithm) when two or more CCAs propagate respective new override layer messages that include conflicting override primitives operating on the same feature. For example, if one override layer from a first CCA changes the surface color feature of a cube to be blue, and another override layer of a second CCA changes the surface color feature of that same cube to be orange, then the conflict management function may implement a conflict protocol to determine which override will govern. For example, the conflict management function may send a conflict notification to users of one or both of the CCAs notifying them of the conflict so that they may coordinate to determine a resolution, and notify the conflict management function of the selected resolution (e.g., which override primitive will be maintained, and/or which will be discarded).

In some embodiments, one or more server nodes of the CCCP itself may execute software that generates a virtual rendering of the common interaction environment through which users (e.g., users of the CCAs and/or other applications) and/or agents (e.g., computer algorithms and/or artificial intelligence-implemented agents) may interface to visualize and/or interact with a scene comprising one or more of the various elements included in the root USD file. That is, the CCCP may maintain an analytical real-time representation of the scene described by the root USD file and provide access to that scene as a common interaction environment to various client nodes. The CCCP server node(s) may generate a computer-generated simulation that renders the features of elements defined by one or more of the scene definition layers of the root USD file and/or as altered by one or more of the override layers propagated by one or more of the CCAs. In some embodiments, users and/or agents operating within the virtual rendering of the common interaction environment produced by the CCCP may also initiate edits to features of the elements in the scene (e.g., using CCAs hosted directly by the CCCP). As an example, a user of a CCP-hosted CCA may move a position of one or more elements, which may represent a deviation in a position feature of that element relative to the position defined by the baseline scene definition layers of the root USD file. In such instances, a CCCP server node may generate the one or more new override layers that capture the override primitives that capture the edited position of the element. Those override layers produced by the CCCP server node may be propagated to client nodes by adding the new override layers to the root USD file and notifying the subscribing CCAs at the client nodes through a new layer message, in the same manner as performed for new override layers propagated by client node-hosted CCAs as described herein.

In some embodiments, one or more of the CCAs of client nodes coupled to the common interaction environment may generate edits to features of elements based on user (e.g., content author) inputs. In some embodiments, such edits to features may be generated by non-human agents. For example, in some embodiments, a CCA (either client node- or CCP-hosted) may include an artificial intelligence (AI)-based agent (e.g., that uses generative AI models) that perceive elements of the common interaction environment as inputs (e.g., using computer vision techniques), and based on those inputs generates alterations to the elements of the common interaction environment which may be captured as edits by the CCA and used to generate override primitives that are embedded in a propagated override layer. For example, in some embodiments, a generative AI agent may perceive a disordered collection of boxes in the common interaction environment and generate override primitives that reposition those boxes into a tidy stack of boxes, and the CCA may propagate an override layer that the CCCP server node and/or other CCA may use to unclutter their rendering of the scene.

In some embodiments, bi-directional connectors may be used to transmit information between a first CCA and a scene location within the common interaction environment. The information being transmitted may be sliced or otherwise selected based on a number of different parameters, such as in accordance with a defined workflow or according to a specification for a given type of CCA, among other options. In operation, a client node may use a first CCA and provide a set of information to the scene location that is accessible by a second CCA and a second client node, which may be using the first CCA or a different second CCA. Based on the information provided to the scene location, one or more features of the content from the first CCA may be viewable and/or modifiable within the second CCA, which may then be provided back to the scene location to be viewed by the first client node. If each of the client nodes are using different CCAs, then the amount of editing/modification may be limited based on the information identified and extracted by the scene location. However, if each of the clients are using a common CCA, then a copy of the native file may also be provided between the two client nodes, thereby allowing additional editing and collaboration. In this manner, a collaborative environment is provided by the CCCP where a subset of information is extracted from presented content to permit access using a different CCA.

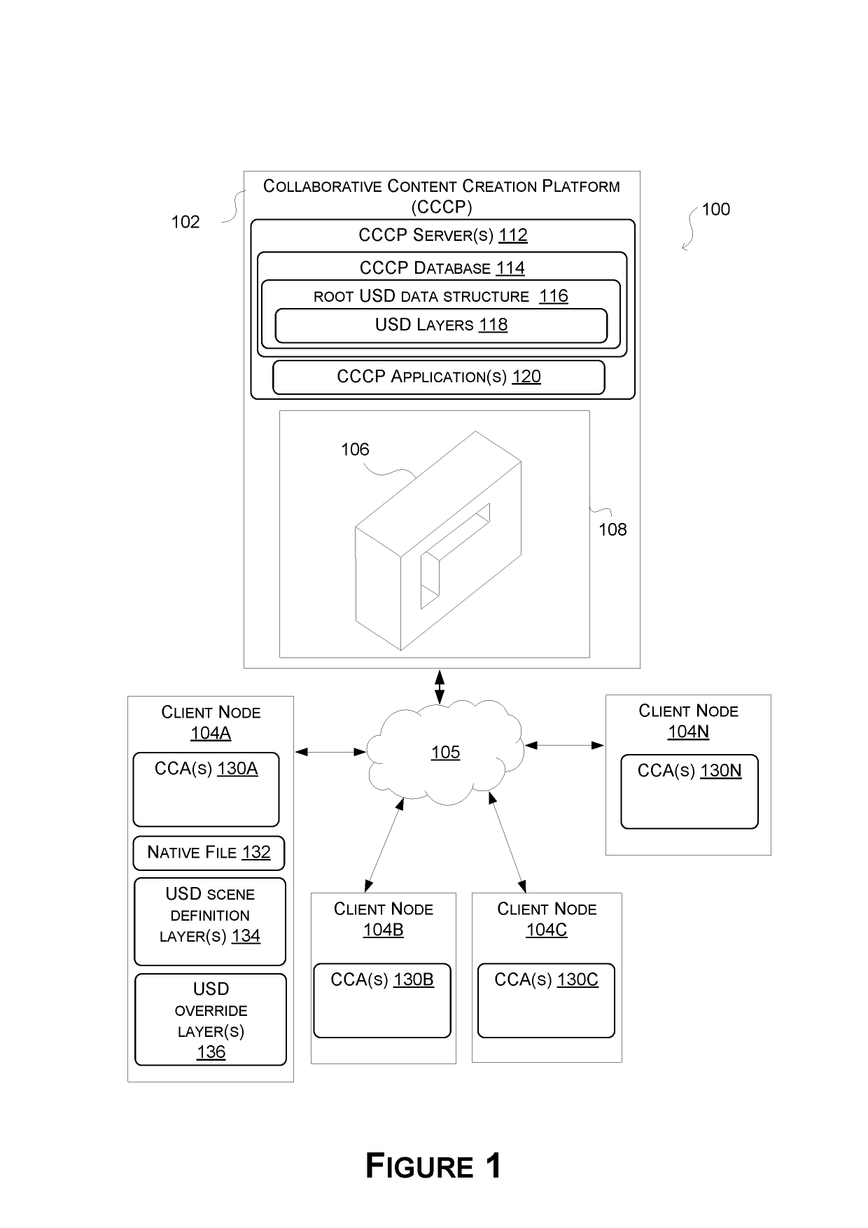

With reference to FIG. 1, FIG. 1 is an example data flow diagram for an example collaborative environment 100 comprising a content creation platform 102, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

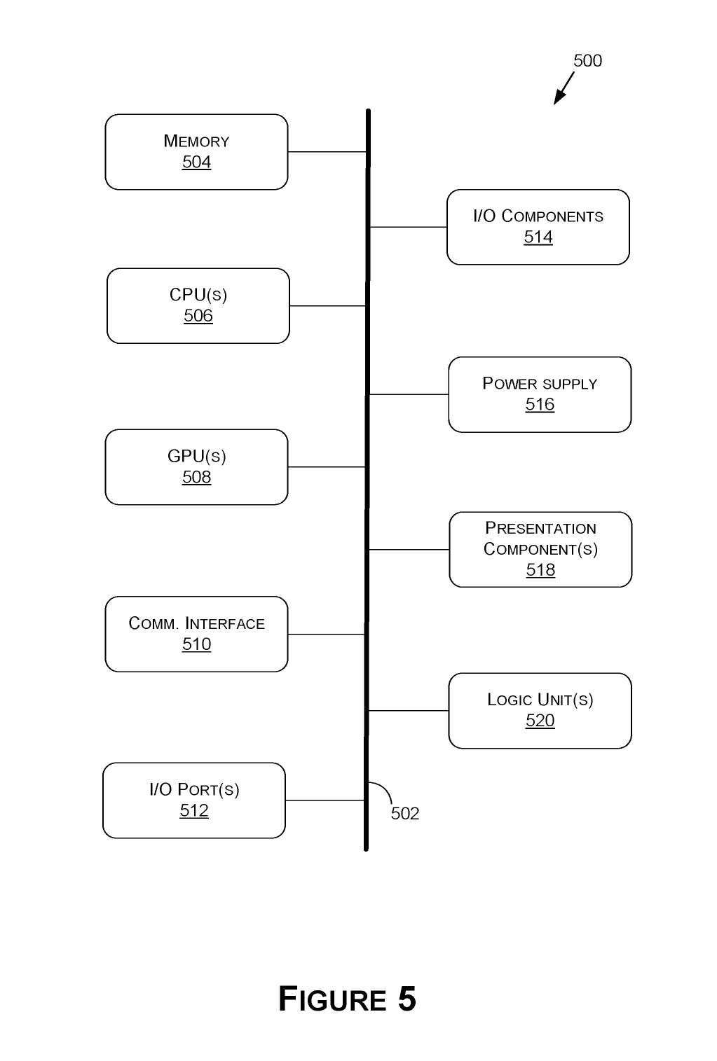

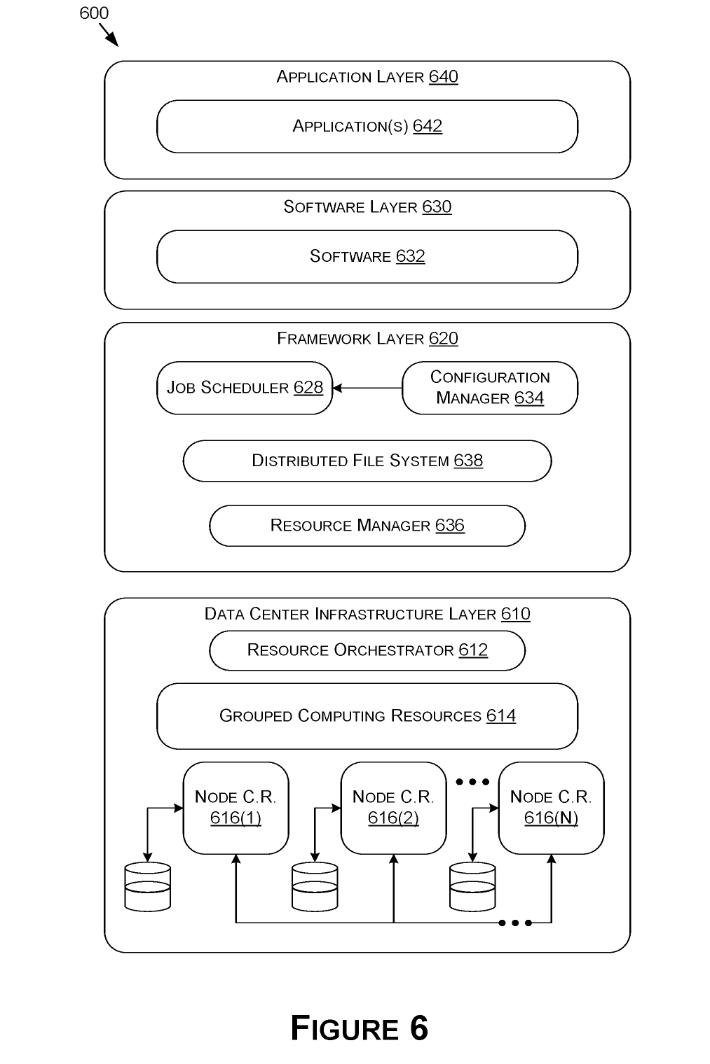

FIG. 1 illustrates an example collaborative environment 100 that can be used with embodiments of the present disclosure. In this example, the collaborative environment 100 includes a collaborative content creation platform (CCP) 102 through which one or more collaborators may operate CCA(s) 130 (shown as 130A-130N) distributed across one or more client nodes 104 (shown as 104A-104N) to collaborate and/or interact with one or more objects 106 rendered within a computer-generated common interaction environment 108. In some embodiments, the CCCP 102 comprises one or more CCCP server nodes (servers 112), comprising one or more processors executing one or more CCCP applications 120 to perform one or more functions of the CCCP 102 described herein. The one or more CCCP servers 112 may host one or more CCCP databases 114 that include a root USD data structure 116 (e.g., a file comprising a scene graph) that may be used by the CCCP applications 120 and/or CCA(s) 130 to render one or more elements of a scene (e.g., one or more objects 106) within the common interaction environment 108. In some embodiments, the one or more client nodes 104A-104N may comprise networked computing devices (e.g., computing device 500 discussed with respect to FIG. 5) coupled to the one or more CCCP servers 112 via at least one network 105 (e.g., the Internet). In some embodiments, one or more functions performed by the one or more CCCP servers 112 and/or CCA(s) 130 may be performed at least in part using a cloud computing platform 600 such as described with respect to FIG. 6. The CCCP 102 may be integrated into and/or in communication with one or more of such distributed and/or cloud computing environments that permits one or more users to collaborate and/or view objects and/or scenes within the common interaction environment 108 via client nodes 104A-104N. In some embodiments, the CCCP 102 may be deployed as one or more tools or features accessible within the common interaction environment 108. The tools and/or features may be supported by underlying processing hardware of the CCCP 102 (such as described with respect to FIGS. 5 and 6) that executes stored software instructions responsive to one or more commands. The commands may be provided as an input, such as by a user executing operations via the CCAs 130A-130N and/or CCCP application(s) 120. In some embodiments, the CCCP applications(s) 120 may include one or more applications that operate within the common interaction environment 108 in the same manner as described for CCAs 130A-130N.

In FIG. 1, client nodes 104A-104N are using a heterogeneous set of CCAs 130A-130N to collaborate on the one or more objects 106 and/or other elements within the common interaction environment 108 defined by the root USD data structure 116. In this example, the one or more objects 106 are shown as a 3D volume that includes features such as, but not limited to, its geometry boundary, a transform position within a 3D space, and the like. Other features of the one or more objects 106 represented by the root USD data structure 116 may include characteristics such as, but not limited to, material characteristics (e.g., the material(s) that the one or more objects 106 are composed of), weight, mass, textures, physical coefficients (e.g., friction coefficients, reflection coefficients, etc.), audio data (e.g., sounds emitted by the one or more objects 106), an inventory count, and/or other characteristics.

In FIG. 1, client nodes 104A-104N use the CCCP 102 to collaborate on the one or more objects 106. Each of these client nodes 104A-104N and their respective CCAs 130A-130N may represent a user and/or software instructions executing according to one or more workflows. For example, the client nodes 104A-104N may include human users that are associated with working on an assembly that includes the object(s) 106 as a component. In some embodiments, client nodes 104A-104N and/or CCAs 130A-130N may be responsive to other instructions or workflows. By way of example, the client nodes 104A-104N may be components of a generative artificial intelligence system collaborating to generate content within the common interaction environment 108. As previously mentioned, the client nodes 104A-104N may be using a diverse, non-homogenous, set of CCAs 130A-130N to modify or otherwise collaborate on the object(s) 106. For example, each of the client nodes 104A and 104B may be using a first CCA that is the same as the CCA used to generate the object 106. However, the client node 104C may be using a second CCA, and the client node 104N may be using a third CCA. To facilitate collaboration, embodiments of the present disclosure may provide for override layers that may be used to communicate a sequence of override primitives (e.g., a directed acyclic graph) that may be applied against baseline scene definition layers to render an updated/current version of the scene within the common interaction environment 108. The propagation of override layers between client nodes 104 using new layer messages permits any changes made to features of elements of the common interaction environment 108 to be passed by a CCA into the common interaction environment 108 via the root USD data structure 116 and shared with various other CCAs – even to CCAs different from the software program that initiated the changes – without having to propagate other primitives and scene definition information.

For example, as previously described, a common interaction environment 108 hosted by the CCCP servers 112 of CCCP 102 may be instantiated based on a root USD data structure 116 (e.g., a file comprising a scene graph) comprising a plurality of USD layers 118. The USD layers 118 may define a contribution to a scene graph of the root USD data structure 116 (that is used to render one or more aspects of elements (e.g., object(s) 106) within the common interaction environment 108. The root USD data structure 116 may comprise a scene graph data structure comprising a set of graph nodes arranged in a graph or tree structure to organize logical and/or special features of a computer graphics scene. The USD layers 118 may comprise one or more graph nodes of the root USD data structure 116 and thus may represent primitives associated with an object, attribute, or a transformation matrix that applies to each child node of that node.

In some embodiments, a CCA 130A working one or more USD layers 118 of the root USD data structure 116 may subscribe (e.g., via an API provided by the CCCP application(s) 120) to one or more scene definition layers of the USD layers 118 to access one or more graph nodes associated with features of the one or more objects 106. In some embodiments, the CCA 130A may synchronize or otherwise load those scene definition layers from the root USD data structure 116 to a local memory of the client node 104A (shown at USD scene definition layer(s) 134). The CCA 130A may operate on definition primitives included with the USD scene definition layer(s) 134 as part of a workflow for collaboratively updating the one or more objects 106 and/or other elements of the common interaction environment 108. As the CCA 130A performs operations that apply edits to features defined by the definition primitives of the USD scene definition layer(s) 134, those operations are tracked at that client node 104A in the form of a sequence of override primitives generated by the CCA 130A. Such override primitives are collected in the form of an override scene graph represented by one or more USD override layers 136.

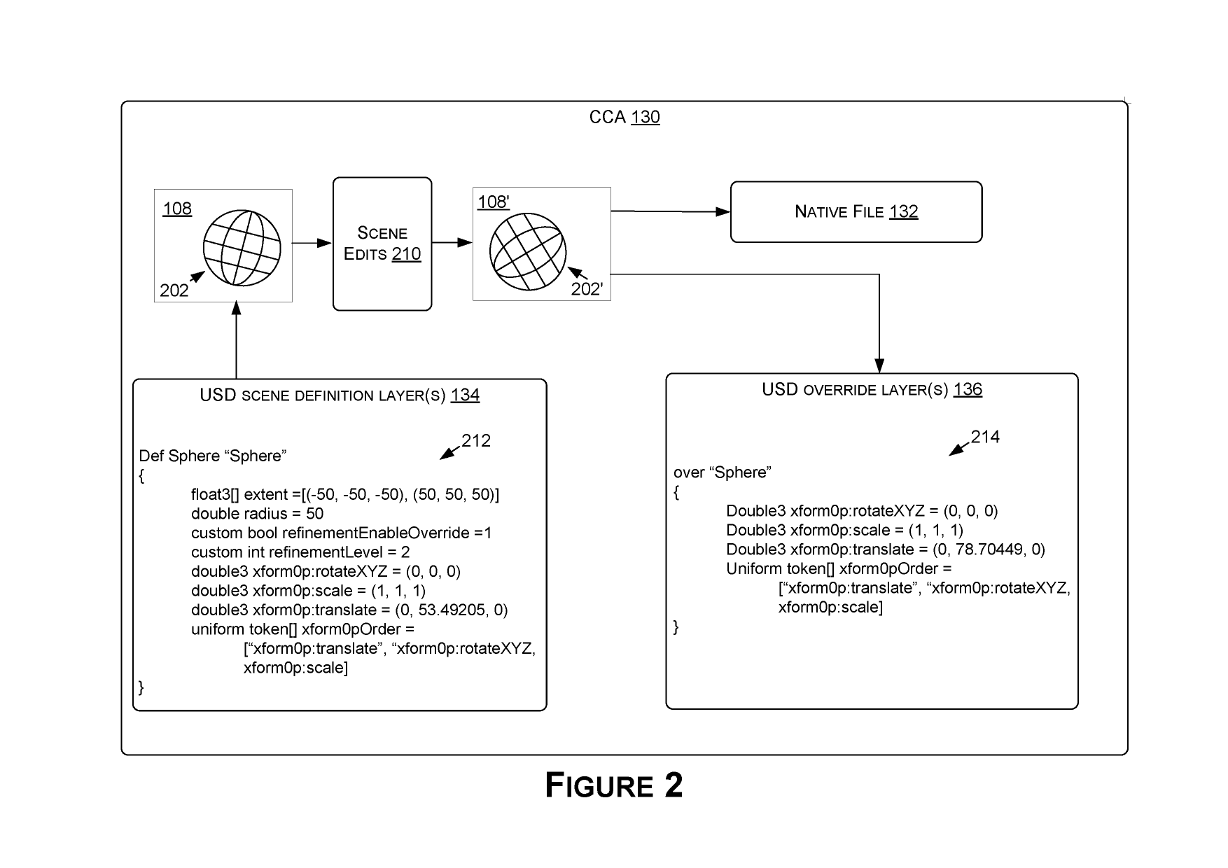

For example, referring to FIG. 2, FIG. 2 illustrates a process for generating USD override layer(s) 136 based on updating features (e.g., characteristics) of one or more objects 106 produced from definition primitives represented by the USD scene definition layer(s) 134. As shown in FIG. 2, the USD scene definition layer(s) 134 may include a USD definition primitive 212 that specifies parameters for defining an object 202 of the common interaction environment 108. In this example, the CCA 130 reads the USD scene definition layer(s) 134 and identifies a node comprising the USD definition primitive 212 to render object 202 as a spherical object. As shown in FIG. 2, the USD definition primitive 212 may specify parameters of object 202 that define the object as a sphere having, for example, a specified position, radius, rotation, scale factor, and/or translation. A user and/or generative AI system may apply one or more instructions for the CCA 130 to apply one or more scene edits 210 to one or more of the features of the object 202 that are established by the USD definition primitive 212. In response to the one or more scene edits 210, the CCA 130 generates a modified version of the common interaction environment 108’ that includes a modified instance of the object 202 – shown as modified object 202’ – that reflects the one or more scene edits 210. As the CCA 130 processes the scene edits 210, the CCA 130 also tracks which definition primitives of the USD scene definition layer(s) 134 are affected (e.g., modified) due to the scene edits 210 and generates one or more override primitives 214 that represent delta information. That is, the one or more override primitives 214 instruct the CCA 130 to use the parameters provided by the one or more override primitives 214 when rendering that element (object) in place of the corresponding parameters specified for that element by the USD definition primitive 212. Here in this example, the scene edits 210 apply a change to the Y plane translation value specified by the USD definition primitive 212. Accordingly, the CCA 130 generates an override primitive 214 that specifies the updated Y plane translation value, and that override primitive 214 is saved (e.g., appended) to the USD override layer(s) 136. When the CCA 130 proceeds to render the object 202 of the common interaction environment 108, the object will be rendered based at least in part on the USD scene definition layer(s) 134, which includes the USD definition primitive 212. However, based on processing the graph nodes of the USD scene definition layer(s) 134, the CCA 130 will identify and apply the nodes of the override scene graph comprising the override primitive 214 to render the modified object 202’ (e.g., having the editing Y plane translation relative to object 202). In some embodiments, the CCA 130 may also save the modified object 202’ and/or modified version of the common interaction environment 108’ to a feature-based native file 132 at the client node 104.

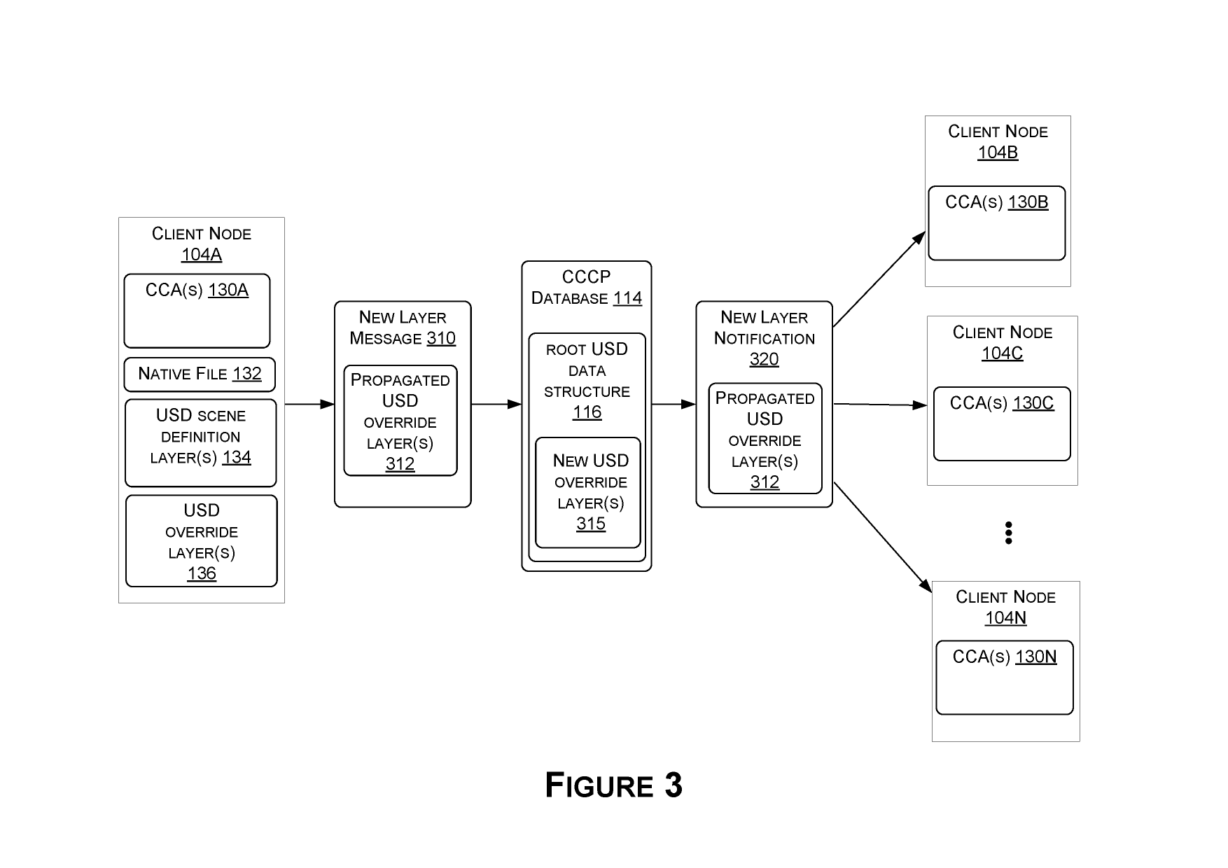

As the CCA 130 processes edits applied to elements of the common interaction environment 108, the override primitives generated from those edits may be accumulated (e.g., sequentially) in the USD override layer(s) 136 at the client node 104. Based on the USD framework, CCA 130A may propagate the edits to other CCAs (e.g., CCAs 130B-130N) at other client nodes subscribed to the USD layers 118 of the root USD data structure 116. As an example, FIG. 3 illustrates a process for override layer propagation in accordance with some embodiments of this disclosure. As shown in FIG. 3, a CCA 130A may initiate propagation of one or more USD override layer(s) 136 by transmitting a new layer message 310 (e.g., via network 105) to the CCCP server(s) 112 (e.g., to CCCP database 114). The new layer message 310 may include propagated USD override layer(s) 312 based on the one or more USD override layer(s) 136 comprising override primitives (e.g., override primitive 214). In some embodiments, the CCA 130A may determine when to push a new layer message 310 to the CCCP server(s) 112 based on one or more criteria. For example, the CCA 130A may push the new layer message 310 on a manual basis (e.g., based on a user input), based on a predetermined frequency (e.g., once every specified time interval), and/or on an event-based criteria (e.g., the size of the USD override layer 136 and/or the number of accumulated override primitives 214 reaching a threshold). In response to receiving the new layer message 310, the CCCP server(s) 112 may add the override primitive contents from the propagated USD override layer(s) 312 as a new USD override layer 315 to the root USD data structure 116 (e.g., by adding one or more USD layers 315 comprising the override scene graph of propagated USD override layer(s) 312).

The CCCP server(s) 112 may transmit a new layer notification 320 message to the other CCAs 130B-130N subscribed to root USD data structure 116 that indicates that the new USD override layer 315 has been added. The CCAs 130B-130N receiving the new layer notification 320 may elect to read and selectively apply override primitives propagated via the new USD override layer 315 added to the root USD file. In some embodiments, the new layer notification 320 may include the propagated USD override layer(s) 312 (or other representation of the new USD override layer 315) as a payload delivered to the other CCA 130B-130N.

Because the payload of the new layer message 310 and/or new layer notification 320 may be reserved for the propagated USD override layer(s) 312 and corresponding override primitives, the payloads of the messages are relatively sparse as compared to a message that would carry scene definition layers that may include definition primitives and/or other types of primitives and scene definition information. As such, the sharing of the one or more USD override layer(s) 136 comprising the override primitives generated by CCA(s) 130A is a relatively lightweight operation consuming substantially fewer computing and/or network resources than transmitting full USD layers.

In some embodiments, the propagated USD override layer(s) 312 may format the override primitives as an ASCII or other text-based representation of the override primitives, or a representation compressed into a binary serialization or other format to make the message smaller and/or less resource-intensive to transport. In some embodiments, the propagated USD override layer(s) 312 may be communicated to the CCCP server 112 and/or propagated to one or more CCAs 130A-130-N as a USD payload.

In some embodiments, the CCCP application(s) 120 may provide one or more APIs that are exposed to the CCAs 130A-130N at client nodes 104A-104N, to permit the CCAs 130A-130N to perform one or more of the override layer propagation functions described herein. For example, a CCA may send a call to a messaging API of the CCCP 102 to send the CCCP server 112 a message that includes propagated USD override layer(s) 312 to propagate edits made by that CCA. Another API provided by the CCCP application(s) 120 may implement a subscription function used by CCAs 130A-130N to specify layers of the root USD data structure 116 for which they subscribe to receive notifications (e.g., new layer notifications 320) when corresponding new USD override layers 315 become available.

The CCAs receiving the propagated USD override layer(s) 312 may thus be notified of precisely which features of which elements within the common interaction environment 108 were updated by the CCA applying the scene edits, and what the updated parameter values of those features are. The CCAs receiving the common interaction environment 108 may parse through the sequence of override primitives to identify edits in features that are relevant for that CCA – and disregard further processing of override primitives deemed not relevant. For example, a first CCA that manages surface textures of an element within the common interaction environment may disregard override primitives from the common interaction environment 108 that rearrange the position (e.g., location and/or rotation) of that element, since surface texture and object position are fully independent features of the element.

In some embodiments, because the override primitives are presented in the propagated USD override layer(s) 312 sequentially in the order that the edit operations were performed, a CCA 130A-130N receiving the propagated USD override layer(s) 312 may efficiently find the most recent occurrence of an override primitive associated with a feature and apply that override primitive. Override primitives within the propagated USD override layer(s) 312 that are superseded by subsequent override primitives may be disregarded as stale. In some embodiments, a propagated USD override layer(s) 312 may include timestamps applied by the CCA indicating a time that the edit operation was performed and/or that the override layer was created. In such embodiments, the CCA receiving the propagated USD override layer(s) 312 may determine which override primitives to apply (e.g., the most recent) based at least on one or more of the timestamps. In some embodiments, based on a propagated USD override layer(s) 312, a CCA may merge one or more of the override primitives back into the baseline definition primitives in the USD scene definition layers 134 and/or the root USD data structure 116 to establish the updated features as the new baseline definition. That is, the parameters of one or more override primitives from a propagated USD override layer(s) 312 may be used by a CCCP application 120 to modify a definition primitive specified by other USD layers 118 of the root USD data structure 116. In some embodiments, a propagated USD override layer(s) 312 may be served by a CCCP server 112 based on a file format plug that exposes an API that provides a receiving CCA with an underlying format schema of the propagated USD override layer(s) 312 to facilitate reading and/or parsing of the override primitives included in that propagated USD override layer(s) 312.

In some embodiments, the CCCP application(s) 120 may include a conflict management function (e.g., algorithm) that operates when two or more CCAs 130A-130N send a new layer message 310 with propagated USD override layer(s) 312 that include conflicting override primitives operating on the same feature. The conflict management function may send a conflict notification to users of one or both of the CCAs notifying them of the conflict so that they may coordinate to determine a resolution, and notify the conflict management function of the selected resolution (e.g., which override primitive will be maintained, and/or which will be discarded). In some embodiments, the conflict management function may also delay and/or otherwise impose an ordering on propagated USD override layer(s) 312 received from different CCAs 130. For example, if two different CCAs 130 interact with the same feature of the one or more objects 106, the conflict management function may provide an indication that the corresponding definition primitive modified by multiple override primitives may provide an instruction to: make an update according to the order the propagated USD override layer(s) 312 were received; disregard the first propagated USD override layer(s) 312 in favor of the second propagated USD override layer(s) 312; disregard the second propagated USD override layer(s) 312 in favor of the first propagated USD override layer(s) 312; or various combinations thereof. For example, different propagated USD override layer(s) 312 received within a threshold period of time of one another from different CCA(s) 130A-130N may be evaluated and then one or more rules may be applied, such as disregarding the first propagated USD override layer(s) 312 because the likelihood of rendering the second propagated USD override layer(s) 312 before seeing the result of the first propagated USD override layer(s) 312 may be greater than some threshold. Additionally, in various embodiments, a messenger service may be provided to notify users of rapid changes to different primitives, which may be used to moderate or otherwise encourage communication between the CCA(s) 130A-130N.

In some embodiments, one or more of the CCCP applications 120 may generate a rendering of the common interaction environment 108 through which users (e.g., users of the CCAs 130A-130N and/or other applications) and/or agents (e.g., computer algorithms and/or artificial intelligence-implemented agents) may interface to visualize and/or interact with the scene comprising one or more of the various elements included in the root USD data structure 116. That is, the CCCP 102 may maintain an analytical real-time representation of the scene described by the root USD data structure 116 and provide access to that scene as a common interaction environment 108 to the various client nodes 104A-104N. The CCCP applications 120 may generate a computer-generated simulation that renders the features of elements defined by one or more of the scene definition layers of the root USD data structure 116 and/or as altered by one or more of the propagated USD override layer(s) 312 propagated by one or more of the CCAs 130A-130N. In some embodiments, users and/or agents operating within the virtual rendering of the common interaction environment 108 produced by the CCCP 102 may also initiate edits to features of the elements in the scene (e.g., using CCCP applications 120 comprising CCAs hosted directly by the CCCP server(s) 112). As an example, a user of a CCCP 102-hosted CCA may move a position of one or more elements, which may represent a deviation in a position feature of that element relative to the position defined by the baseline scene definition layers of the root USD data structure 116. In such instances, a CCCP 102 hosted CCA may generate the one or more new override layers that capture the override primitives that capture the edited position of the element. Those override layers produced by CCCP 102-hosted CCA may be propagated to client nodes by adding the new USD override layers 315 to the root USD data structure 116 and notifying the subscribing CCAs at the client nodes through a new layer notification 320, in the same manner as performed for propagated USD override layer(s) 312 propagated by client node-hosted CCAs 130A-130N as described herein.

Accordingly, systems and methods of the present disclosure may be used to increase and/or improve collaboration within a common environment between users executing different, often non-compatible, underlying software systems.

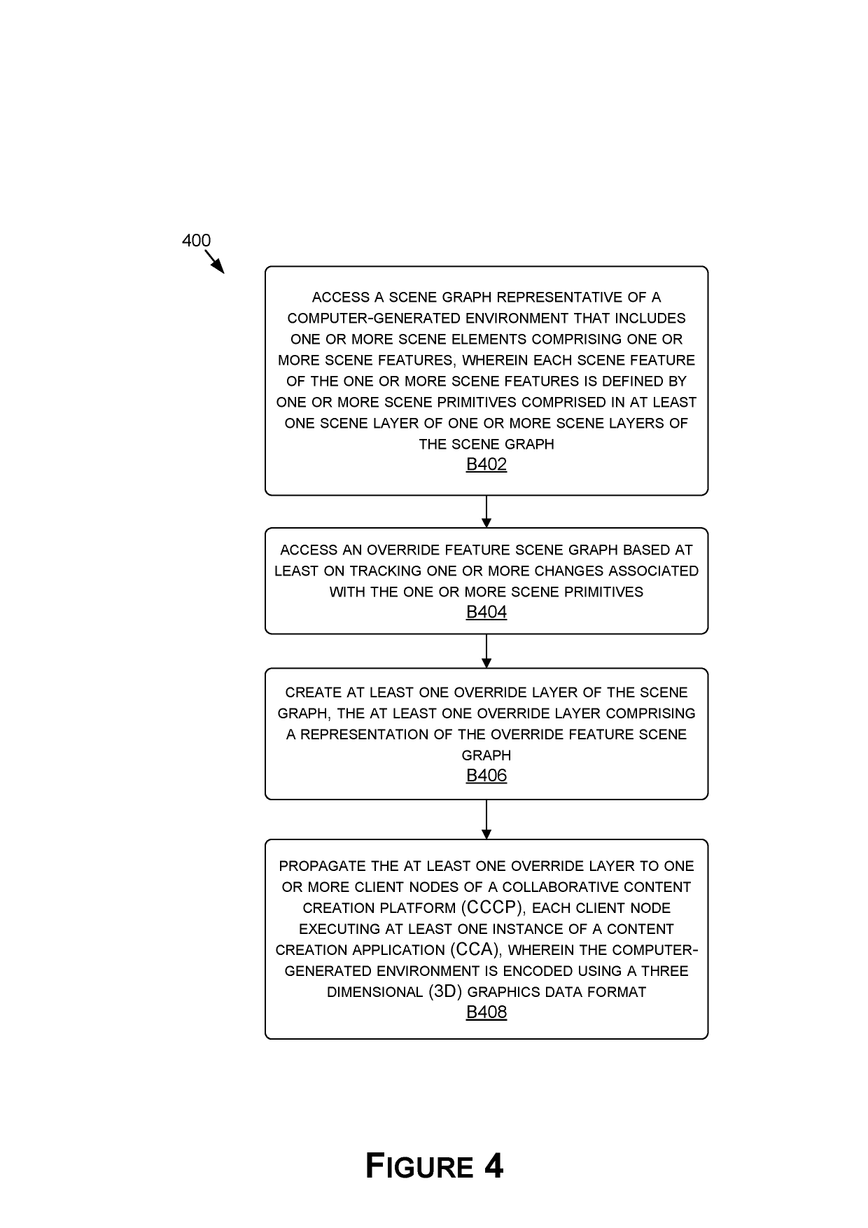

Now referring to FIG. 4, FIG. 4 is a flow diagram showing a method 400 for override-based data change propagation for distributed collaborative content creation platforms, in accordance with some embodiments of the present disclosure. The features and elements described herein with respect to the method 400 of FIG. 4 may be used in conjunction with, in combination with, or substituted for elements of any of the other embodiments discussed herein and vice versa. Further, the functions, structures, and other descriptions of elements for embodiments described in FIG. 4 may apply to like or similarly named or described elements across any of the figures and/or embodiments described herein and vice versa.

Each block of method 400, described herein, comprises a computing process that may be performed using any combination of hardware, firmware, and/or software. For instance, various functions may be carried out by one or more processors comprising processing circuitry and executing instructions stored in memory. The methods may additionally, or alternatively, be embodied as computer-usable instructions stored on computer storage media. The methods may be provided by a standalone application, a service or hosted service (standalone or in combination with another hosted service), or a plug-in to another product, to name a few. In addition, method 400 is described, by way of example, with respect to the collaborative environment 100 comprising the content creation platform 102 of FIG. 1. However, these methods may additionally or alternatively be executed by any one system, or any combination of systems, including, but not limited to, those described herein.

In some embodiments, method 400 may generally be directed to tracking, across one or more instances of one or more content creation applications, one or more changes associated with one or more scene primitives organized across one or more scene definition layers representing one or more elements of a virtual scene environment; and propagating the one or more changes to one or more client nodes of a collaborative content creation platform (CCCP) that are subscribed, through the CCCP, to the one or more scene primitives, wherein the propagating comprises generating an override feature scene graph based at least on the one or more changes, creating at least one override layer comprising a representation of the override feature scene graph, and instructing a server node of the CCCP to add the at least one override layer to a representation of the virtual scene environment.

The method 400, at block B402, includes accessing a scene graph representative of a computer-generated environment that includes one or more scene elements comprising one or more scene features, wherein each scene feature of the one or more scene features is defined by one or more scene primitives comprised in at least one scene layer of one or more scene layers of the scene graph. The scene graph may include one or more scene definition layers, wherein the one or more scene definition layers comprise one or more scene definition primitives that define one or more characteristics of the one or more features. The one or more scene definition layers may be based at least on a root scene definition framework hosted by a server node of a collaborative content creation platform. In some embodiments, the root scene definition framework may comprise a root USD data structure such as, but not limited to, an open universal scene description (OpenUSD) data structure. For example, as discussed with respect to FIG. 1, one or more CCCP servers 112 of a CCCP 102 may host one or more CCCP databases 114 that include a root USD data structure 116 (e.g., a file comprising a scene graph) that may be used by the CCCP applications 120 and/or CCA(s) 130 to render one or more elements of a scene (e.g., one or more objects 106) within the common interaction environment 108. A common interaction environment 108 hosted by the CCCP servers 112 of CCCP 102 may be instantiated based on a root USD data structure 116 (e.g., a file comprising a scene graph) comprising a plurality of USD layers 118. The USD layers 118 may define a contribution to a scene graph of the root USD data structure 116 (that is used to render one or more aspects of elements (e.g., object(s) 106) within the common interaction environment 108. The root USD data structure 116 may comprise a scene graph data structure comprising a set of graph nodes arranged in a graph or tree structure to organize logical and/or special features of a computer graphics scene. The USD layers 118 may comprise one or more graph nodes of the root USD data structure 116 and thus may represent primitives associated with an object, attribute, or a transformation matrix that applies to each child node of that node. In some embodiments, a CCA 130A working one or more USD layers 118 of the root USD data structure 116 may subscribe (e.g., via an API provided by the CCCP application(s) 120) to one or more scene definition layers (e.g., a scene definition scene graph) of the USD layers 118 to access one or more graph nodes associated with features of the one or more objects 106. In some embodiments, the CCA 130A may synchronize or otherwise load those scene definition layers from the root USD data structure 116 to a local memory of the client node 104A (shown at USD scene definition layer(s) 134).

The method 400, at block B404, includes accessing an override feature scene graph based at least on tracking one or more changes associated with the one or more scene primitives. For example, the method may produce an override feature scene graph based at least on tracking one or more changes associated with the one or more scene definition primitives. The override scene graph may comprise a USD data structure layer. For example, the CCA 130A may operate on definition primitives included with the USD scene definition layer(s) 134 as part of a workflow for collaboratively updating the one or more objects 106 and/or other elements of the common interaction environment 108. The method may generate one or more override primitives based at least on tracking the one or more changes associated with the one or more scene definition primitives to generate the override feature scene graph. As the CCA 130A performs operations that apply edits to features defined by the definition primitives of the USD scene definition layer(s) 134, those operations are tracked at that client node 104A in the form of a sequence of override primitives generated by the CCA 130A. Such override primitives are collected in the form of an override scene graph represented by one or more USD override layers 136. The override feature scene graph (e.g., defined by USD override layer(s) 136) may comprise one or more override primitives to override parameters of at least one of the one or more scene primitives of the computer-generated environment, at least one scene primitive of the one or more scene primitives being associated with at least one of: a geometry of one or more elements of the computer-generated environment, a surface texture of one or more elements of the computer-generated environment, a material composition of one or more elements of the computer-generated environment, a surface color of one or more elements of the computer-generated environment, a lighting environment of one or more elements of the computer-generated environment, a weight value of one or more elements of the computer-generated environment, or an inventory quantity of one or more elements of the computer-generated environment. In some embodiments, one or more processors execute one or more generative artificial intelligence (AI)-based agents within the computer-generated environment, wherein the one or more generative AI-based agents generate the one or more changes associated with the one or more scene primitives based at least on a computer-based perception of the computer-generated environment.

The method 400, at block B406, includes creating at least one override layer of the scene graph, the at least one override layer comprising a representation of the override feature scene graph. For example, referring to FIG. 2, FIG. 2 illustrates a process for generating USD override layer(s) 136 based on updating features (e.g., characteristics) of one or more objects 106 produced from definition primitives represented by the USD scene definition layer(s) 134. As shown in FIG. 2, the USD scene definition layer(s) 134 may include a USD definition primitive 212 that specifies parameters for defining an object 202 of the common interaction environment 108. As the CCA 130 processes edits applied to elements of the common interaction environment 108, the override primitives generated from those edits may be accumulated (e.g., sequentially) in the USD override layer(s) 136 at the client node 104. Based on the USD framework, CCA 130A may propagate the edits to other CCAs (e.g., CCAs 130B-130N) at other client nodes subscribed to the USD layers 118 of the root USD data structure 116. In some embodiments, the at least one override layer is generated by a first instance of a first CCA subscribed with the CCCP to at least a portion of the computer-generated environment and propagated to at least one of: one or more second instances of the first CCA or one or more instances of at least one second CCA subscribed with the CCCP to the at least the portion of the computer-generated environment. In some embodiments, the at least one override layer is encoded according to a 3D graphics data format. The at least one override may be generated by an application hosted by the collaborative content creation platform and propagated by the server node to one or more digital content creation (DCC) applications subscribed to the root scene definition framework. The at least one override layer may represent a chronological sequence of override primitives generated based at least on a chronological order of the one or more changes associated with the one or more scene definition primitives. In some embodiments, the method may include applying a timestamp in the at least one override layer indicating a time that the one or more changes associated with the one or more scene definition primitives were made.

The method 400, at block B408, includes propagating the at least one override layer to one or more client nodes of a collaborative content creation platform (CCCP), each client node executing at least one instance of a content creation application (CCA), wherein the computer-generated environment is encoded using a three dimensional (3D) graphics data format. In some embodiments, the 3D graphics data format comprises open universal scene description (OpenUSD). In some embodiments, the method may propagate at least one override layer to one or more client nodes coupled to the server node of the collaborative content creation platform based at least on instructing the server node of the CCCP to add the at least one override layer (e.g., to the root scene definition framework). As an example, FIG. 3 illustrates a process for override layer propagation in accordance with some embodiments of this disclosure. As shown in FIG. 3, a CCA 130A may initiate propagation of one or more USD override layer(s) 136 by transmitting a new layer message 310 (e.g., via network 105) to the CCCP Server(s) 112 (e.g., to CCCP database 114). The new layer message 310 may include propagated USD override layer(s) 312 based on the one or more USD override layer(s) 136 comprising override primitives (e.g., override primitive 214). The message to the server node may cause the server node to add the at least one override layer to the root scene definition framework. For example, in response to receiving the new layer message 310, the CCCP server(s) 112 may add the override primitive contents from the propagated USD override layer(s) 312 as a new USD override layer 315 to the root USD data structure 116 (e.g., by adding one or more USD layers 315 comprising the override scene graph of propagated USD override layer(s) 312).

The CCCP server(s) 112 may transmit a new layer notification 320 message to the other CCA 130B-130N subscribed to root USD data structure 116, which indicates that the new USD override layer 315 has been added. As such, in some embodiments, the method may include processing one or more second override layers received from the server node, and selectively applying one or more override primitives defined by the one or more second override layers to the one or more scene definition primitives of the one or more scene definition layers. The CCAs 130B-130N receiving a new layer notification 320 may elect to read and selectively apply override primitives propagated via the new USD override layer 315 added to the root USD file. In some embodiments, the CCAs 130B-130N receiving the new layer notification 320 may parse through the one or more second override layers to find a last occurrence in the one or more second override layers of an override primitive associated with a scene definition primitive of the one or more scene definition layers to apply the last occurrence of the override primitive to the scene definition primitive.

In some embodiments, the systems and methods described herein may be performed within an immersive simulation environment (e.g., NVIDIA’s DriveSIM platform, NVIDIA’s Omniverse platform, etc.) using simulated data (e.g., simulated sensor data of simulated sensors of a virtual or simulated machine). For example, simulated sensor data and/or map data may be used to identify elements of interest (e.g., objects, regions of interest, etc.) within the common interaction environment 108 provided by CCCP 102, and may use this information to perform operations (e.g., navigation) associated with one or more virtual machines within the environment. These simulated operations may be used to test performance of the underlying algorithms, systems, and/or processes prior to deploying them in the real world. In some instances, a simulation based on the common interaction environment 108 may be used to generate synthetic training data – e.g., training data including objects, systems, structures, regions of interest, and/or subregions of interest from within the simulation. The synthetic training data (in addition to or alternatively from real-world data) may then be processed to determine geometry, visualizations, and/or other information related to such subjects of interest. In any example, such as where a simulation environment is used for testing, validation, training, etc., the simulation environment and/or associated training data may be rendered or otherwise generated using one or more light transport algorithms – such as ray-tracing and/or path-tracing algorithms. In some embodiments, the simulation environment and/or one or more objects, features, or components thereof may be generated or managed within a three-dimensional (3D) content collaboration platform (e.g., NVIDIA’s Omniverse) for industrial digitalization, generative physical AI, and/or other use cases, applications, or services. For example, a content collaboration platform (e.g., CCCP 102) or system may include a system for using or developing universal scene descriptor (USD) (e.g., OpenUSD) data for managing objects, features, scenes, etc., within a simulated environment, digital environment, etc. In some of the embodiments disclosed herein, the platform may include real physics simulation, such as using NVIDIA’s PhysX SDK, in order to simulate real physics and physical interactions with simulations hosted by the platform. The content collaboration platform may integrate OpenUSD along with ray-tracing/path-tracing/light transport simulation (e.g., NVIDIA’s RTX rendering technologies) into software tools and simulation workflows for building, training, deploying, or testing AI systems – such as systems for testing, validating, training (e.g., machine learning models, neural networks, etc.), and/or other tasks related to automotive, robot, machine, or other applications.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models – such as one or more large language models (LLMs) and/or one or more vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice – such an inference microservice (e.g., NVIDIA NIMs) – which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples – such as where the model(s) is large – the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs - such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA’s Triton Inference Server, and/or one or more APIs for high performance deep learning inference, which may include an inference runtime and model optimizations that deliver low latency and high throughput for production applications – such as NVIDIA’s TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### EXAMPLE COMPUTING DEVICE

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof. In some embodiments, one or more aspects of a client node 104 and/or CCCP server(s) 112 may be performed by, or implemented using, the computing device 500.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508. In some embodiments, one or more functions of a client node 104, CCA(s) 130, and/or CCCP 102 may be performed by, or implemented using software instructions executed by the CPU(s) 506, GPU(s) 508, and/or logic unit(s) 520.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.). In some embodiments, CCA(s) 130 may render one or more objects 106 and/or other elements of common interaction environment 108 on presentation component(s) 518 of a client node 104.

### EXAMPLE DATA CENTER

FIG. 6 illustrates an example data center 600 that may be used in at least one embodiments of the present disclosure. The data center 600 may include a data center infrastructure layer 610, a framework layer 620, a software layer 630, and/or an application layer 640. In some embodiments, one or more functions of a client node 104, CCA(s) 130, and/or CCCP 102 may be performed by, or implemented using data center 600.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM). In some embodiments, one or more functions of a client node 104, CCA(s) 130, and/or CCCP 102 may be performed by, or implemented using software instructions executed by the node C.R.s 616(1)-616(N).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark^{TM} (hereinafter “Spark”) that may use distributed file system 638 for large-scale data processing (e.g., "big data"). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In some embodiments, one or more functions of CCA(s) 130, and/or CCCP 102 described herein may be performed by, or implemented using software 632 and/or applications 642.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5 – e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
access a scene graph representative of a computer-generated environment that includes one or more scene elements comprising one or more scene features, wherein each scene feature of the one or more scene features is defined by one or more scene primitives comprised in at least one scene layer of one or more scene layers of the scene graph;
access an override feature scene graph based at least on tracking one or more changes associated with the one or more scene primitives;
create at least one override layer of the scene graph, the at least one override layer comprising a representation of the override feature scene graph; and
propagate the at least one override layer to one or more client nodes of a collaborative content creation platform (CCCP), each client node executing at least one instance of a content creation application (CCA), wherein the computer-generated environment is encoded using a three dimensional (3D) graphics data format.

2. The one or more processors of claim 1, wherein the 3D graphics data format comprises open universal scene description (OpenUSD).

3. The one or more processors of claim 1, wherein the one or more processors are further to synchronize the one or more scene layers of the scene graph.

4. The one or more processors of claim 1, wherein the one or more processors are further to generate one or more override primitives based at least on tracking the one or more changes associated with the one or more scene primitives to generate the override feature scene graph.

5. The one or more processors of claim 1, wherein the one or more processors are further to send a message to at least one server node of the CCCP to cause the at least one server node to add the at least one override layer.

6. The one or more processors of claim 1, wherein the at least one override layer is generated by a first instance of a first CCA subscribed with the CCCP to at least a portion of the computer-generated environment and propagated to at least one of: one or more second instances of the first CCA or one or more instances of at least one second CCA subscribed with the CCCP to the at least the portion of the computer-generated environment.

7. The one or more processors of claim 1, wherein the at least one override layer is encoded according to a 3D graphics data format.

8. The one or more processors of claim 1, wherein the override feature scene graph comprises one or more override primitives to override parameters of at least one of the one or more scene primitives of the computer-generated environment, at least one scene primitive of the one or more scene primitives being associated with at least one of:
a geometry of one or more elements of the computer-generated environment,
a surface texture of one or more elements of the computer-generated environment,
a material composition of one or more elements of the computer-generated environment,
a surface color of one or more elements of the computer-generated environment,
a lighting environment of one or more elements of the computer-generated environment,
a weight value of one or more elements of the computer-generated environment, or
an inventory quantity of one or more elements of the computer-generated environment.

9. The one or more processors of claim 1, wherein the at least one override layer represents a chronological sequence of override primitives generated based at least on a chronological order of the one or more changes associated with the one or more scene primitives.

10. The one or more processors of claim 1, wherein the one or more processors are further to apply a timestamp in the at least one override layer indicating a time that the one or more changes associated with the one or more scene primitives were made.

11. The one or more processors of claim 1, wherein the one or more processors are further to:
process one or more second override layers; and
selectively apply one or more override primitives of the one or more second override layers to the one or more scene primitives of the one or more scene layers.

12. The one or more processors of claim 11, wherein the one or more processors are further to parse through the one or more second override layers to find a last occurrence in the one or more second override layers of an override primitive associated with a scene primitive of the one or more scene layers to apply the last occurrence of the override primitive to the scene primitive.

13. The one or more processors of claim 1, wherein the one or more processors are further to execute one or more generative artificial intelligence (AI)-based agents within the computer-generated environment, wherein the one or more generative AI-based agents generate the one or more changes associated with the one or more scene primitives based at least on a computer-based perception of the computer-generated environment.

14. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more vision language models (VLMs);
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

15. A system comprising one or more processors to:
generate one or more override primitives based at least on tracking one or more changes associated with one or more scene primitives of one or more scene layers that collectively define elements of a virtual scene, the one or more scene layers defined using a 3D graphics format and hosted using one or more server nodes of a collaborative content creation platform;
create at least one override layer comprising a representation of the one or more override primitives; and
propagate the at least one override layer to one or more client nodes coupled to the one or more server nodes of the collaborative content creation platform based at least on instructing the one or more server nodes to add the at least one override layer to the one or more scene layers that collectively define the virtual scene.

16. The system of claim 15, wherein the at least one override layer represents the one or more override primitives based at least on a scene graph data structure that represents the virtual scene.

17. The system of claim 16, wherein the one or more processors are further to generate the one or more override primitives based at least on tracking the one or more changes associated with the one or more scene primitives to generate an override feature scene graph.

18. The system of claim 15, wherein the at least one override layer represents a chronological sequence of override primitives generated based at least on a chronological order of the one or more changes associated with the one or more scene primitives.

19. The system of claim 15, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more vision language models (VLMs);
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
tracking, across one or more instances of one or more content creation applications, one or more changes associated with one or more scene primitives organized across one or more scene definition layers representing one or more elements of a virtual scene environment; and
propagating the one or more changes to one or more client nodes of a collaborative content creation platform (CCCP) that are subscribed, through the CCCP, to the one or more scene primitives, wherein the propagating comprises generating an override feature scene graph based at least on the one or more changes, creating at least one override layer comprising a representation of the override feature scene graph, and instructing a server node of the CCCP to add the at least one override layer to a representation of the virtual scene environment.
